(19) United States
(12) Patent Application Publication
(10) Pub. No.: US 2012/0191240 A1
(43) Pub. Date: Jul. 26, 2012

(54) METHODS AND APPARATUS FOR REMOVING AN ITEM FROM A CONVEYOR SYSTEM

(75) Inventor: Scott C. GILMORE, Elgin, IL (US)

(73) Assignee: SMART MOTION ROBOTICS, INC., Sycamore, IL (US)

(21) Appl. No.: 13/358,471

(22) Filed: Jan. 25, 2012

Related U.S. Application Data
(60) Provisional application No. 61/436,167, filed on Jan. 25, 2011.

(51) Int. Cl. B65G 47/64; G06F 7/00

(52) U.S. Cl. 700/228; 414/749.1; 414/751.1

(57) ABSTRACT

Methods and apparatus for removing an item from a conveyor system are provided. In some aspects, an escapement assembly includes a sensor system configured to detect a target item of a plurality of items on a feed conveyor of a conveyor system. The feed conveyor is configured to facilitate transport of the plurality of items to a first location. The escapement assembly also includes an escape conveyor configured to couple to a body of the conveyor system such that at least a portion of the escape conveyor is above the feed conveyor. The escapement assembly also includes a delivery assembly configured to pick the target item from the feed conveyor and to place the target item onto the escape conveyor. The escape conveyor is configured to facilitate transport of the target item to a second location different from the first location.

### CROSS-REFERENCES TO RELATED APPLICATIONS

The present application claims the benefit of U.S. Provisional Patent Application Ser. No. 61/436,167, entitled “Methods and Apparatus for Removing Items on a Conveyor System,” filed on Jan. 25, 2011, which is hereby incorporated by reference in its entirety for all purposes.

### FIELD

The subject technology generally relates to production and/or assembly line equipment, and more particularly to methods and apparatus for removing items from a conveyor system.

### BACKGROUND

In egg packing systems, egg cartons may be passed along on a conveyor belt. Automated equipment may pick up the egg cartons from the conveyor belt and subsequently place the egg cartons into cases for packaging the egg cartons. However, the automated equipment is typically designed to pick up the egg cartons when the egg cartons are closed. If an egg carton passed along on the conveyor belt is open, the automated equipment may attempt to pick up the open egg carton and cause damage to the eggs within the open egg carton (e.g., by spilling the eggs and/or clamping the eggs).

### SUMMARY

According to various aspects of the subject technology, an escapement assembly for removing an item from a conveyor system is provided. The escapement assembly comprises a sensor system configured to detect a target item of a plurality of items on a feed conveyor of a conveyor system. The feed conveyor is configured to facilitate transport of the plurality of items to a first location. The escapement assembly also comprises an escape conveyor configured to couple to a body of the conveyor system such that at least a portion of the escape conveyor is above the feed conveyor. The escapement assembly also comprises a delivery assembly configured to pick the target item from the feed conveyor and to place the target item onto the escape conveyor. The escape conveyor is configured to facilitate transport of the target item to a second location different from the first location.

According to various aspects of the subject technology, a machine-readable medium encoded with executable instructions for removing an item from a conveyor system is provided. The instructions comprise code for detecting, by a sensor system, a target item of a plurality of items on a feed conveyor. The feed conveyor is configured to facilitate transport of the plurality of items to a first location. The instructions also comprise code for picking, by a delivery assembly, the target item from the feed conveyor. The instructions also comprise code for placing, by the delivery assembly, the target item onto an escape conveyor. At least a portion of the escape conveyor is above the feed conveyor. The escape conveyor is configured to facilitate transport of the target item to a second location different from the first location.

According to various aspects of the subject technology, an escapement assembly for removing an open carton of one or more eggs from a conveyor system is provided. The escapement assembly comprises a sensor system configured to detect an open carton of one or more eggs of a plurality of cartons of one or more eggs on a feed conveyor of a conveyor system. The feed conveyor is configured to facilitate transport of the plurality of cartons of one or more eggs to a first location in a first direction. The escapement assembly also comprises an escape conveyor configured to couple to a body of the conveyor system such that at least a portion of the escape conveyor is above the feed conveyor. The escapement assembly also comprises a delivery assembly configured to pick the open carton of one or more eggs from the feed conveyor and to place the open carton of one or more eggs onto the escape conveyor. The delivery assembly is configured to traverse a first plane of motion and a second plane of motion to pick the open carton of one or more eggs and/or place the open carton of one or more eggs. The second plane of motion is different from the first plane of motion. The escape conveyor is configured to facilitate transport of the open carton of one or more eggs to a second location in a second direction. The second location is different from the first location. The second direction is different from the first direction.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates a side view of a conveyor system, in accordance with various aspects of the subject technology.

FIG. 2 illustrates a side view of the conveyor system opposite the view shown in FIG. 1, in accordance with various aspects of the subject technology.

FIG. 3 illustrates a front view of the conveyor system, in accordance with various aspects of the subject technology.

FIG. 4 illustrates a rear view of the conveyor system opposite the view shown in FIG. 3, in accordance with various aspects of the subject technology.

FIG. 5 illustrates a detailed side view of an escapement assembly, in accordance with various aspects of the subject technology.

FIG. 6 illustrates an example of a method for removing an item from a conveyor system, in accordance with various aspects of the subject technology.

FIG. 7 is a block diagram illustrating components of a controller, in accordance with various aspects of the subject technology.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

According to various aspects of the subject technology, methods and apparatus for removing items from a conveyor system are provided. In particular, undesirable items on a conveyor system, such as open egg cartons, may be detected and removed from the conveyor system. In some aspects, one or more sensors may be mounted on the conveyor system and may be used to distinguish between a desirable item (e.g., a closed egg carton) and an undesirable item (e.g., an open egg carton), which may be referred to herein as a target item. The one or more sensors may detect the target item and send a signal to a programmable logic controller (PLC). In response, the PLC may send one or more signals to an escapement assembly to pick up and remove the target item from the conveyor system. The escapement assembly, for example, may be a mechanical device that may move in multiple planes of motion to pick up the target item and place it onto another location. In some aspects, the escapement assembly may travel horizontally and vertically with the help of pneumatic cylinders to pick and/or place the target item with gripping plates.

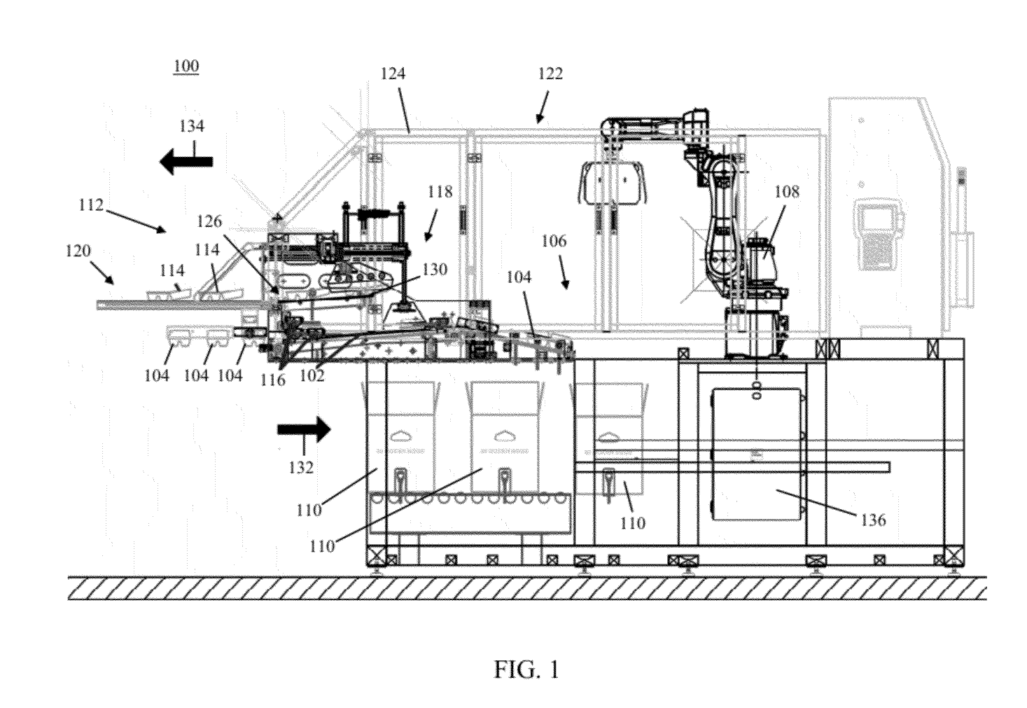

FIG. 1 illustrates a side view of conveyor system 100, in accordance with various aspects of the subject technology. Conveyor system 100, for example, may be an egg carton packing system (e.g., a series 2250 SmartPacker™ from Smart Motion Robotics, Inc.) that may be used to pack cartons of eggs. Conveyor system 100 comprises feed conveyor 102. Feed conveyor 102, for example, may comprise at least one of a conveyor belt and a conveyor roller. Feed conveyor 102 may facilitate transport of one or more cartons of eggs 104 to location 106. For example, feed conveyor 102 may be a powered conveyor belt that can transport one or more cartons of eggs 104 to location 106. Location 106 may comprise an area at which the one or more cartons of eggs 104 can be retrieved for packaging. In some aspects, conveyor system 100 comprises robotic arm 108 configured to pack the one or more cartons of eggs 104 into one or more cases 110. For example, robotic arm 108 may be configured to pick up the one or more cartons of eggs 104 from location 106 and place the one or more cartons of eggs 104 into one or more cases 110. In some aspects, robotic arm 108 may utilize an end of arm tool as described in U.S. Patent Application Publication No. US 2009/0320417, entitled “Linear Actuated Robotic Packaging Device and Method,” to pick up the one or more cartons of eggs 104 and place them into one or more cases 110. U.S. Patent Application Publication No. US 2009/0320417 is hereby incorporated by reference in its entirety for all purposes.

According to various aspects of the subject technology, escapement assembly 112 may be added to conveyor system 100 (e.g., installed or mounted onto body 122 of conveyor system 100) to detect and remove a target item (e.g., an open carton of eggs 114) from feed conveyor 102 before robotic arm 108 has a chance to pack the open carton of eggs 114 into the one or more cases 110. Escapement assembly 112 comprises sensor system 116 (e.g., one or more sensors) configured to detect the target item on feed conveyor 102. Escapement assembly 112 also comprises escape conveyor 126 and delivery assembly 118, which is configured to pick the target item from feed conveyor 102 and to place the target item onto escape conveyor 126. Escape conveyor 126, for example, may comprise at least one of a conveyor belt and a roller conveyor. Escape conveyor 126 may facilitate transport of the target item to location 120, which is different from location 106. Location 120, for example, may comprise an area at which the target item is separated from other ones of the one or more cartons of eggs 104.

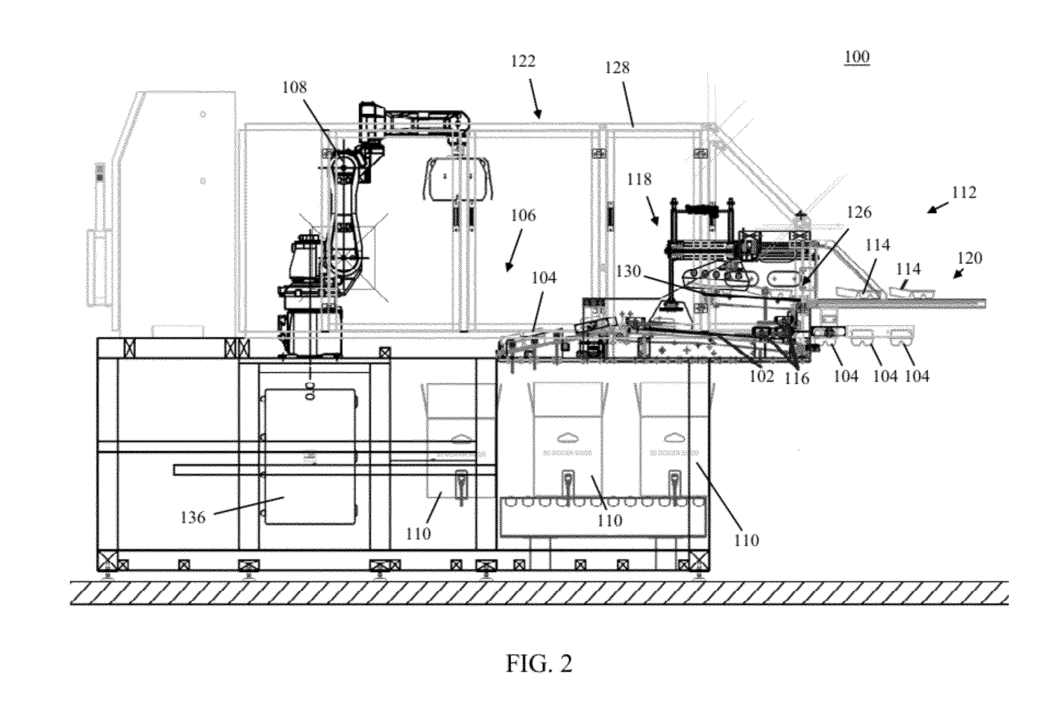

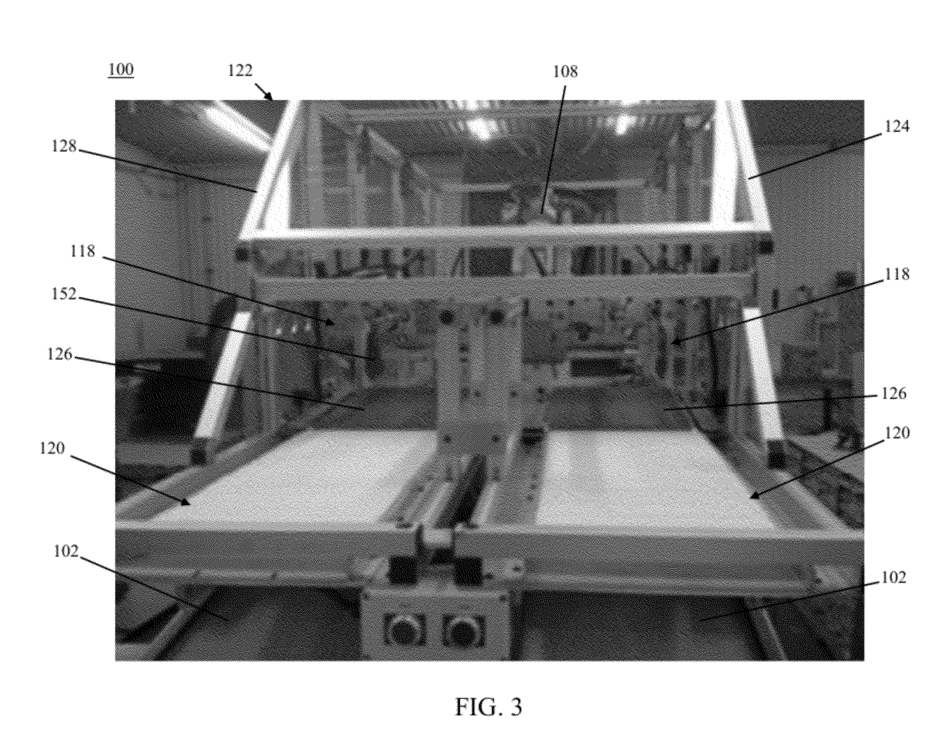

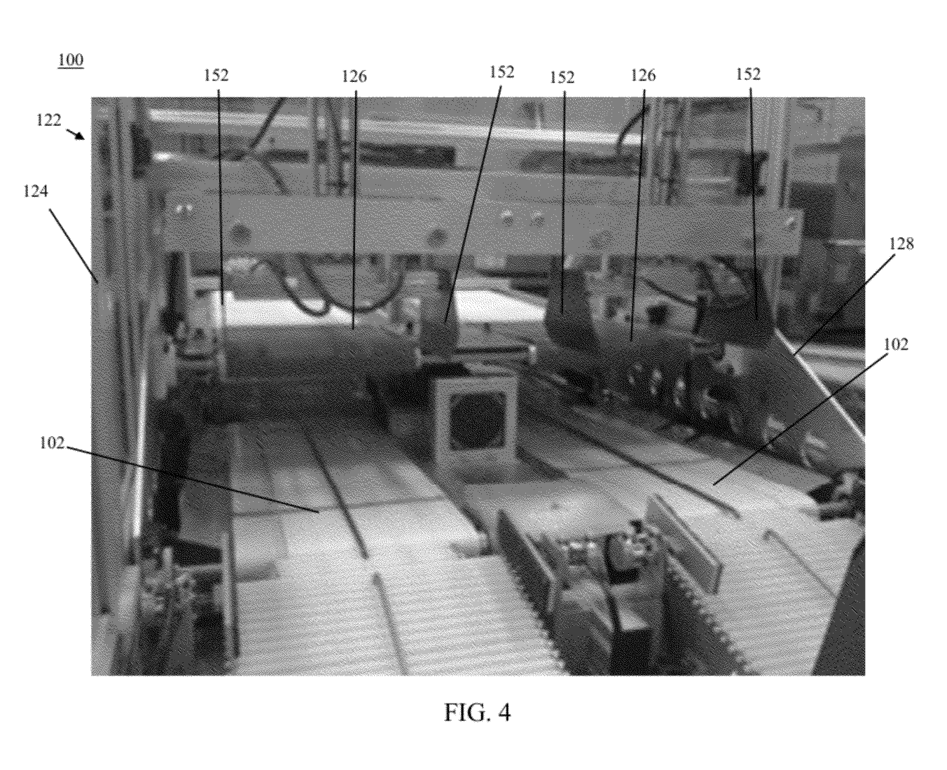

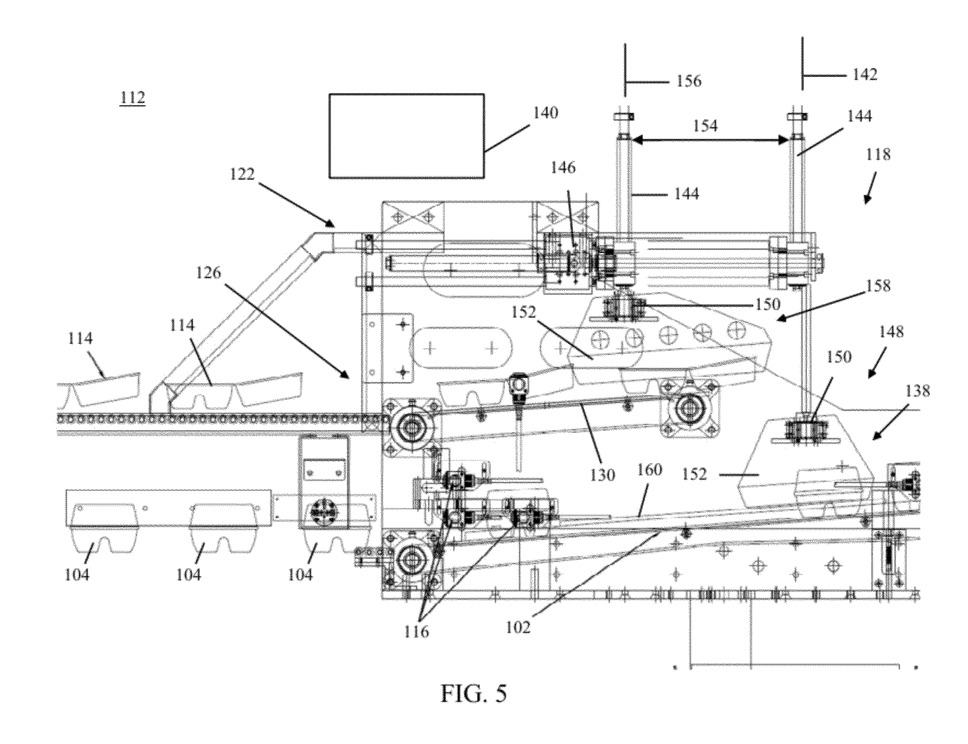

While FIG. 1 illustrates a first side 124 of body 122 of conveyor system 100, FIG. 2 illustrates a second side 128 of body 122 opposite first side 124, in accordance with various aspects of the subject technology. FIG. 3 illustrates a front view of conveyor system 100, in accordance with various aspects of the subject technology. For example, first side 124 is shown on the right side of this figure, while second side 128 is shown on the left side of this figure. Furthermore, FIG. 3 illustrates that conveyor system 100 may comprise multiple feed conveyors 102, multiple sensor systems (not shown), multiple delivery assemblies 118, and multiple escape conveyors 116 being operated next to one another. FIG. 4 illustrates a rear view of conveyor system 100 opposite the view shown in FIG. 3, in accordance with various aspects of the subject technology. FIG. 5 illustrates a detailed side view of escapement assembly 112, in accordance with various aspects of the subject technology.

According to certain aspects, escape conveyor 126 is coupled to body 122 such that the target item may be conveniently and quickly picked from feed conveyor 102 and placed onto escape conveyor 126. For example, referring to FIGS. 1, 2, 3, and 5, escape conveyor 126 is coupled to body 122 such that at least a portion 130 of escape conveyor 126 is above feed conveyor 102. Feed conveyor 102 is disposed between first side 124 and second side 128, and may be coupled to at least one of first side 124 and second side 128. In some aspects, escape conveyor 126 is disposed between first side 124 and second side 128, and may also be coupled to at least one of first side 124 and second side 128. The portion 130 of escape conveyor 126 is directly above at least a portion 160 of feed conveyor 102. In some aspects, the portion 130 of escape conveyor 126 is substantially parallel with the portion 160 of feed conveyor 102. For example, the portion 130 of escape conveyor 126 may be tilted less than 10 degrees relative to the portion 160 of feed conveyor 102. In some aspects, the portion 130 of escape conveyor 126 may be tilted more than at least 10 degrees relative to the portion 160 of feed conveyor 102.

Referring to FIG. 1, feed conveyor 102 is configured to facilitate transport of the one or more cartons of eggs 104 in a first direction 132, while escape conveyor 126 is configured to facilitate transport of the target item in a second direction 134 different from first direction 132. For example, second direction 134 is opposite first direction 132. In some aspects, escape conveyor 126 is coupled to body 122 such that location 120 may be more easily accessible than location 106, thereby allowing the target item to be easily removed. For example, because escape conveyor 126 is above feed conveyor 102, a height of location 120 may be greater than a height of location 106, which may allow a person to remove the target item without having to bend down to pick up the target item. According to various aspects of the subject technology, although cartons of eggs are described herein, other suitable items may be transported by conveyor system 100, such as machine parts, articles of clothing, or other food products. Furthermore, although the target item is described herein as an open carton of eggs, other suitable target items of interest may be removed from conveyor system 100 and separated from the other items, such as items that are sized differently from the other items, items that are defective compared to the other items, or other undesirable items.

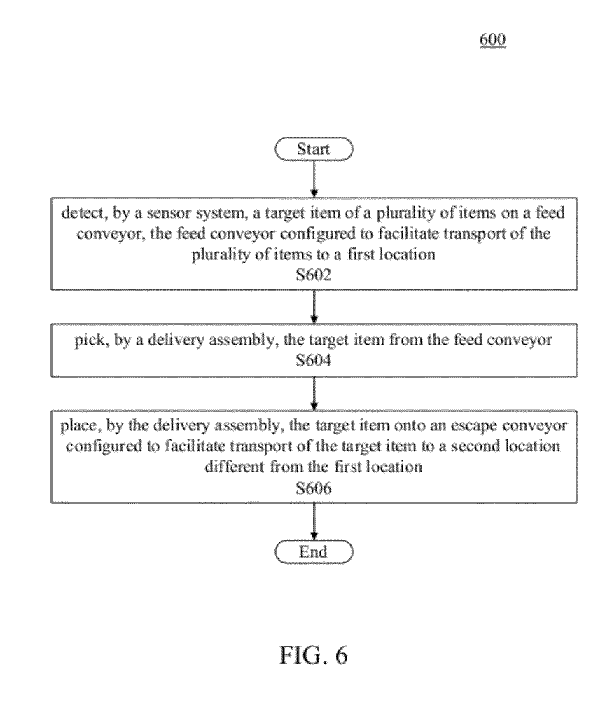

FIG. 6 illustrates an example of method 600 for removing an item from conveyor system 100, in accordance with various aspects of the subject technology. According to step S602, and referring to FIGS. 1, 2, and 5, sensor system 116 may detect the target item on feed conveyor 102. In some aspects, sensor system 116 comprises a vision system configured to visually detect the target item. For example, sensor system 116 may comprise one or more sensors configured to visually detect the target item. The one or more sensors may utilize lasers, cameras, infrared imaging, or other suitable sensing equipment to detect the target item. Each of the one or more sensors may be coupled to body 122 such that the one or more sensors are adjacent to at least a portion of feed conveyor 102. For example, each of the one or more sensors may be disposed along at least a portion of feed conveyor 102.

According to various aspects of the subject technology, escapement assembly 112 comprises a controller (e.g., housed in controller enclosure 136). The controller may be coupled to sensor system 116. Sensor system 116 may transmit a detection signal to the controller upon detecting the target item. In some aspects, the detection signal may comprise at least one of an indication of the detection, identification information of the target item, a position of the target item, a velocity of the target item, an acceleration of the target item, and other suitable information for allowing delivery assembly 118 to pick the target item from feed conveyor 102. The controller may determine at least one of a pickup location of the target item on the feed conveyor and a pickup time of the target item based on the detection signal. The controller may also generate a delivery signal based on the determined pickup location and/or pickup time. In some aspects, the delivery signal may comprise at least one of an instruction to pick the target item, the pickup location, the pickup time, an instruction to place the target item, a place location on escape conveyor 126, a place time of the target item on escape conveyor 126, and other suitable information for allowing delivery assembly 118 to pick the target item from feed conveyor 102 and to place the target item onto escape conveyor 126. The controller may be coupled to delivery assembly 118, and may transmit the delivery signal to delivery assembly 118. Delivery assembly 118 may pick and/or place the target item based on the delivery signal.

According to step S604 in FIG. 6, delivery assembly 118 may pick the target item from feed conveyor 102. For example, as shown in FIG. 5, delivery assembly 118 may traverse to pickup location 138 to pick the target item from feed conveyor 102. According to step S606, delivery assembly 118 may place the target item onto escape conveyor 126. For example, delivery assembly 118 may traverse to place location 158 to place the target item onto portion 130 of escape conveyor 126.

According to certain aspects, delivery assembly 118 may traverse two planes of motion to pick the target item and/or place the target item, thereby minimizing the amount of movement and time used to pick and/or place the target item. For example, delivery assembly 118 may traverse plane of motion 140, which may be parallel to a longitudinal axis of feed conveyor 102 and/or escape conveyor 126. Delivery assembly 118 may also traverse plane of motion 142, which is shown as going into and out of the page of FIG. 5 and may be parallel to a transverse axis of feed conveyor 102 and/or escape conveyor 126. Plane of motion 142 is shown as being perpendicular to plane of motion 140. However, plane of motion 142 may be oriented in other suitable ways relative to plane of motion 140.

According to various aspects of the subject technology, delivery assembly 118 comprises arm assembly 144 slidably mounted to body 122 with actuator assembly 146 (e.g., a pneumatic actuator). Delivery assembly 118 also comprises gripping assembly 148 coupled to arm assembly 144. Gripping assembly 148 may be configured to grip the target item. Arm assembly 144 and gripping assembly 148 may be disposed between first side 124 and second side 128 of body 122. Arm assembly 144 may be coupled to at least one of first side 124 and second side 128.

Actuator assembly 146 may position arm assembly 144 such that gripping assembly 148 is positioned at place location 158 or pickup location 138 for picking and/or placing the target item. For example, actuator assembly 146 may slide arm assembly 144 such that gripping assembly 148 is transported to pickup location 138 or place location 158. In some aspects, actuator assembly 146 may slide arm assembly 144 along plane of motion 140 and/or plane of motion 142 to pickup location 138 or place location 158. For example, when gripping assembly 148 is at place location 158, actuator assembly 146 may slide arm assembly 144 towards the right along distance 154 so that gripping assembly 148 may be directly above feed conveyor 102. Actuator assembly 146 may then slide arm assembly 144 in a downward direction along plane of motion 142 so that gripping assembly 148 may be positioned at pickup location 138 to grip the target item. Once gripping assembly 148 has gripped the target item, actuator assembly 146 may slide arm assembly 144 in an upward direction along plane of motion 142 so that gripping assembly 148 and the gripped target item is at a height greater than a height of portion 30 of escape conveyor 126. Actuator assembly 146 may then slide arm assembly 144 towards the left along distance 154 so that gripping assembly 148 may be positioned at place location 158. Gripping assembly 148 may then release its grip on the target item to place the target item onto portion 30 of escape conveyor 126.

In some aspects, delivery assembly 118 is configured to only traverse plane of motion 140 and/or plane of motion 142 to pick and/or place the target item. Moving delivery assembly 118 in this manner provides a non-complex and quick way to pick and/or place the target item. In some aspects, delivery assembly 118 may even be configured to only traverse a first axis (e.g., an axis parallel to plane of motion 140) and a second axis (e.g., an axis parallel to plane of motion 142) to pick and/or place the target item. For example, delivery assembly 118 may move along a horizontal axis and a vertical axis to pick and/or place the target item. According to certain aspects, delivery assembly 118 may traverse three planes of motion to pick and/or place the target item. For example, in addition to traversing plane of motion 140 and plane of motion 142, delivery assembly 118 may also traverse plane of motion 156 (e.g., shown as going into and out of the page of FIG. 5) so that delivery assembly 118 may move in an upward or downward direction while positioned over place location 158. Plane of motion 156, for example, may be parallel to plane of motion 142.

According to certain aspects, gripping assembly 148 comprises gripping actuator 150 and at least one gripping plate 152 coupled to gripping actuator 150. Gripping actuator 150 may move the at least one gripping plate 152 such that it engages the target item for picking the target item from feed conveyor 102 (e.g., at pickup location 138). For example, gripping assembly 148 may be positioned such that the target item is disposed between two gripping plates 152. Gripping actuator 150 may control the two gripping plates 152 such that they clamp the target item. The two gripping plates 152 may continue clamping the target item until gripping assembly 148 is transported to place location 158. Gripping actuator 150 may control the two gripping plates 152 such that they release the target item, thereby placing the target item onto portion 30 of escape conveyor 126.

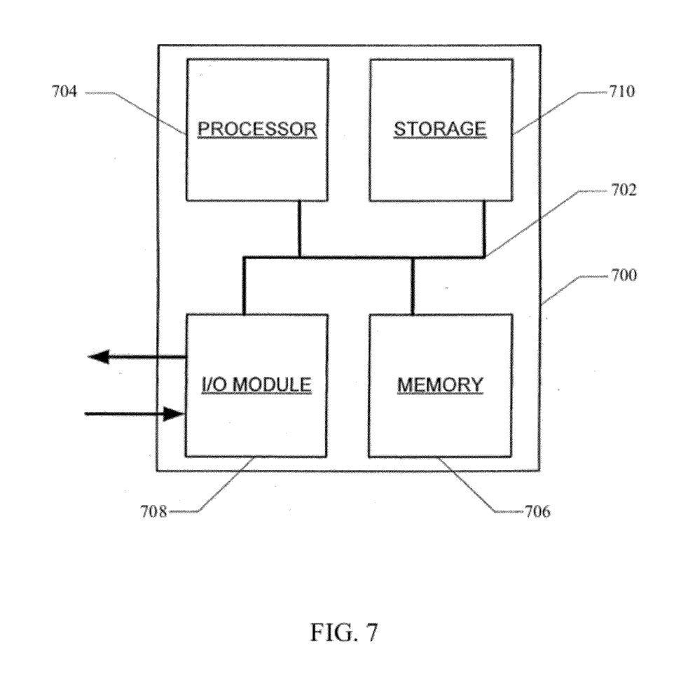

FIG. 7 is a block diagram illustrating components of controller 700, in accordance with various aspects of the subject technology. Controller 700 comprises processor module 704, storage module 710, input/output (I/O) module 708, memory module 706, and bus 702. Bus 702 may be any suitable communication mechanism for communicating information. Processor module 704, storage module 710, I/O module 708, and memory module 706 are coupled with bus 702 for communicating information between any of the modules of controller 700 and/or information between any module of controller 700 and a device external to controller 700. For example, information communicated between any of the modules of controller 700 may include instructions and/or data. In some aspects, bus 702 may be a universal serial bus. In some aspects, bus 702 may provide Ethernet connectivity. In some aspects, controller 700 comprises a programmable logic controller. Controller 700 may be coupled to sensor system 116 for receiving the detection signal. Controller 700 may also be coupled to delivery assembly 118 for transmitting the delivery signal to delivery assembly 118. In some aspects, controller 700 may be housed within controller enclosure 136.

In some aspects, processor module 704 may comprise one or more processors, where each processor may perform different functions or execute different instructions and/or processes. For example, one or more processors may execute instructions for operating system 100, one or more processors may execute instructions for removing an item from system 100, and one or more processors may execute instructions for input/output functions.

Memory module 706 may be random access memory (“RAM”) or other dynamic storage devices for storing information and instructions to be executed by processor module 704. Memory module 706 may also be used for storing temporary variables or other intermediate information during execution of instructions by processor 704. In some aspects, memory module 706 may comprise battery-powered static RAM, which stores information without requiring power to maintain the stored information. Storage module 710 may be a magnetic disk or optical disk and may also store information and instructions. In some aspects, storage module 710 may comprise hard disk storage or electronic memory storage (e.g., flash memory). In some aspects, memory module 706 and storage module 710 are both a machine-readable medium.

Controller 700 is coupled via I/O module 708 to a user interface for providing information to and receiving information from an operator of system 100. For example, the user interface may be a cathode ray tube (“CRT”) or LCD monitor for displaying information to an operator. The user interface may also include, for example, a keyboard or a mouse coupled to controller 700 via I/O module 708 for communicating information and command selections to processor module 704.

According to various aspects of the subject disclosure, methods described herein are executed by controller 700. Specifically, processor module 704 executes one or more sequences of instructions contained in memory module 706 and/or storage module 710. In one example, instructions may be read into memory module 706 from another machine-readable medium, such as storage module 710. In another example, instructions may be read directly into memory module 706 from I/O module 708, for example from an operator of system 100 via the user interface. Execution of the sequences of instructions contained in memory module 706 and/or storage module 710 causes processor module 704 to perform methods to operate system 100 and/or remove items from a conveyor system. For example, a computational algorithm for removing an item from a conveyor system may be stored in memory module 706 and/or storage module 710 as one or more sequences of instructions. Information such as the target item, the detection signal, the pickup location, the pickup time, the delivery signal, the place location, the place time, the first plane of motion, the second plane of motion, the third plane of motion, the longitudinal axis of at least one of the feed conveyor and the escape conveyor, the transverse axis of at least one of the feed conveyor and the escape conveyor, and/or other suitable information may be communicated from processor module 704 to memory module 706 and/or storage module 710 via bus 702 for storage. In some aspects, the information may be communicated from processor module 704, memory module 706, and/or storage module 710 to I/O module 708 via bus 702. The information may then be communicated from I/O module 708 to an operator of system 100 via the user interface.

One or more processors in a multi-processing arrangement may also be employed to execute the sequences of instructions contained in memory module 706 and/or storage module 710. In some aspects, hard-wired circuitry may be used in place of or in combination with software instructions to implement various aspects of the subject disclosure. Thus, aspects of the subject disclosure are not limited to any specific combination of hardware circuitry and software.

The term “machine-readable medium,” or “computer-readable medium,” as used herein, refers to any medium that participates in providing instructions to processor module 704 for execution. Such a medium may take many forms, including, but not limited to, non-volatile media and volatile media. Non-volatile media include, for example, optical or magnetic disks, such as storage module 710. Volatile media include dynamic memory, such as memory module 706. Common forms of machine-readable media or computer-readable media include, for example, floppy disk, a flexible disk, hard disk, magnetic tape, any other magnetic medium, a CD-ROM, DVD, any other optical medium, punch cards, paper tape, any other physical mediums with patterns of holes, a RAM, a PROM, an EPROM, a FLASH EPROM, any other memory chip or cartridge, or any other medium from which a processor can read.

The subject technology is illustrated, for example, according to various aspects described below. These are provided as examples, and do not limit the subject technology.

According to various aspects of the subject technology, a conveyor system is provided. The conveyor system comprises a body and a feed conveyor coupled to the body. The feed conveyor is configured to facilitate transport of a plurality of items thereon to a first location. The conveyor system also comprises an escapement assembly. The escapement assembly comprises: a sensor system configured to detect a target item of the plurality of items on the feed conveyor; an escape conveyor coupled to the body such that at least a portion of the escape conveyor is above the feed conveyor; and a delivery assembly configured to pick the target item from the feed conveyor and to place the target item onto the escape conveyor. The escape conveyor is configured to facilitate transport of the target item to a second location different from the first location.

According to certain aspects, each of the plurality of items comprises a carton of one or more eggs. The target item comprises an open carton of one or more eggs. The first location comprises an area at which one or more of the plurality of items is retrieved for packaging. The second location comprises an area at which the target item is separated from other ones of the plurality of items. The feed conveyor comprises at least one of a conveyor belt and a roller conveyor. The escape conveyor comprises at least one of a conveyor belt and a roller conveyor. The body comprises a first side and a second side opposite the first side. The feed conveyor is disposed between the first side and the second side. The feed conveyor is coupled to at least one of the first side and the second side. The escape conveyor is disposed between the first side and the second side. The escape conveyor is coupled to at least one of the first side and the second side. The at least a portion of the escape conveyor is directly above at least a portion of the feed conveyor. In some aspects, the at least a portion of the escape conveyor is substantially parallel with at least a portion of the feed conveyor. In some aspects, the at least a portion of the escape conveyor is tilted relative to at least a portion of the feed conveyor.

According to certain aspects, the feed conveyor is configured to facilitate transport of the plurality of items in a first direction. The escape conveyor is configured to facilitate transport of the target item in a second direction different from the first direction. The second direction is opposite the first direction. A height of the second location is greater than a height of the first location.

According to certain aspects, the sensor system comprises a vision system configured to visually detect the target item. The sensor system comprises one or more sensors configured to visually detect the target item. Each of the one or more sensors is coupled to the body such that the one or more sensors are adjacent to at least a portion of the feed conveyor. Each of the one or more sensors is disposed along at least a portion of the feed conveyor. The escapement assembly further comprises a controller coupled to the sensor system. The sensor system is configured to transmit a detection signal to the controller based on the detection of the target item. The detection signal comprises at least one of an indication of the detection, identification information of the target item, a position of the target item, a velocity of the target item, and an acceleration of the target item. The controller is configured to determine at least one of a pickup location of the target item on the feed conveyor and a pickup time of the target item based on the detection signal. The controller is configured to generate a delivery signal based on the determined pickup location and/or pickup time. The delivery signal comprises at least one of an instruction to pick the target item, the pickup location, the pickup time, an instruction to place the target item, a place location on the escape conveyor, and a place time of the target item on the escape conveyor. The controller is coupled to the delivery assembly. The controller is configured to transmit the delivery signal to the delivery assembly. The delivery assembly is configured to pick the target item based on the delivery signal. The delivery assembly is configured to place the target item based on the delivery signal.

According to certain aspects, the delivery assembly comprises an arm assembly slidably mounted to the body with an actuator assembly, and a gripping assembly coupled to the arm assembly. The gripping assembly is configured to grip the target item. The actuator assembly is configured to slide the arm assembly such that the gripping assembly is transported to the pickup location or the place location. The actuator assembly is configured to slide the arm assembly along a first plane of motion relative to the body and a second plane of motion relative to the body. The second plane of motion is perpendicular to the first plane of motion.

According to certain aspects, the delivery assembly comprises an arm assembly slidably mounted to the body with an actuator assembly, and a gripping assembly coupled to the arm assembly. The gripping assembly is configured to grip the target item. The actuator assembly comprises a pneumatic actuator. The gripping assembly comprises a gripping actuator and at least one gripping plate coupled to the gripping actuator. The gripping actuator is configured to move the at least one gripping plate such that the at least one gripping plate engages the target item for picking the target item. The gripping actuator is configured to move the at least one gripping plate such that the at least one gripping plate disengages from the target item for placing the target item. The actuator assembly is configured to slide the arm assembly along a first plane of motion relative to the body. The actuator assembly is configured to slide the arm assembly along a second plane of motion relative to the body. The second plane of motion is perpendicular to the first plane of motion. The first plane of motion is parallel to a longitudinal axis of at least one of the feed conveyor and the escape conveyor, and the second plane of motion is parallel to a transverse axis of at least one of the feed conveyor and the escape conveyor.

According to certain aspects, the feed conveyor, the at least a portion of the escape conveyor, the arm assembly, and the gripping assembly is disposed between a first side of the body and a second side of the body opposite the first side of the body. Each of the feed conveyor, the escape conveyor, and the arm assembly is coupled to at least one of the first side and the second side. The at least a portion of the escape conveyor is directly above at least a portion of the feed conveyor, and wherein the arm assembly is slidably mounted to the body such that the arm assembly is above at least one of the escape conveyor and the feed conveyor. The delivery assembly is configured to place the target item onto the at least a portion of the escape conveyor above the feed conveyor.

According to various aspects of the subject technology, an escapement assembly for removing an item from a conveyor system is provided. The escapement assembly comprises a sensor system configured to detect a target item of a plurality of items on a feed conveyor of a conveyor system. The feed conveyor is configured to facilitate transport of the plurality of items to a first location. The escapement assembly also comprises an escape conveyor configured to couple to a body of the conveyor system such that at least a portion of the escape conveyor is above the feed conveyor, and a delivery assembly configured to pick the target item from the feed conveyor and to place the target item onto the escape conveyor. The escape conveyor is configured to facilitate transport of the target item to a second location different from the first location.

According to certain aspects, each of the plurality of items comprises a carton of one or more eggs. The target item comprises an open carton of one or more eggs. The escape conveyor comprises at least one of a conveyor belt and a roller conveyor. The escape conveyor is configured to couple to the body such that the escape conveyor is disposed between a first side of the body and a second side of the body. The feed conveyor is disposed between the first side of the body and the second side of the body. The second side of the body is opposite the first side of the body. The escape conveyor is configured to couple to at least one of the first side and the second side. The escape conveyor is configured to couple to the body such that the at least a portion of the escape conveyor is directly above at least a portion of the feed conveyor. The escape conveyor is configured to couple to the body such that the at least a portion of the escape conveyor is substantially parallel with at least a portion of the feed conveyor. The escape conveyor is configured to couple to the body such that the at least a portion of the escape conveyor is tilted relative to at least a portion of the feed conveyor.

According to certain aspects, the feed conveyor is configured to facilitate transport of the plurality of items in a first direction. The escape conveyor is configured to facilitate transport of the target item in a second direction different from the first direction. The second direction is opposite the first direction. A height of the second location is greater than a height of the first location.

According to certain aspects, the sensor system comprises a vision system configured to visually detect the target item. The sensor system comprises one or more sensors configured to visually detect the target item. Each of the one or more sensors is configured to couple to the body such that the one or more sensors are adjacent to at least a portion of the feed conveyor. Each of the one or more sensors is configured to couple to the body such that the one or more sensors are disposed along at least a portion of the feed conveyor. The escapement assembly further comprises a controller coupled to the sensor system. The sensor system is configured to transmit a detection signal to the controller based on the detection of the target item. The detection signal comprises at least one of an indication of the detection, identification information of the target item, a position of the target item, a velocity of the target item, and an acceleration of the target item. The controller is configured to determine at least one of a pickup location of the target item on the feed conveyor and a pickup time of the target item based on the detection signal. The controller is configured to generate a delivery signal based on the determined pickup location and/or pickup time, the delivery signal comprising at least one of an instruction to pick the target item, the pickup location, the pickup time, an instruction to place the target item, a place location on the escape conveyor, and a place time of the target item on the escape conveyor. The controller is coupled to the delivery assembly. The controller is configured to transmit the delivery signal to the delivery assembly. The delivery assembly is configured to pick the target item based on the delivery signal.

According to certain aspects, the delivery assembly is configured to place the target item based on the delivery signal. The delivery assembly comprises an arm assembly configured to slidably mount to the body with an actuator assembly, and a gripping assembly coupled to the arm assembly. The gripping assembly is configured to grip the target item. The actuator assembly is configured to slide the arm assembly such that the gripping assembly is transported to the pickup location or the place location. The actuator assembly is configured to slide the arm assembly along a first plane of motion relative to the body and a second plane of motion relative to the body, the second plane of motion being different from the first plane of motion. The second plane of motion is perpendicular to the first plane of motion.

According to certain aspects, the delivery assembly comprises an arm assembly configured to slidably mount to the body with an actuator assembly, and a gripping assembly coupled to the arm assembly. The gripping assembly is configured to grip the target item. The actuator assembly comprises a pneumatic actuator. The gripping assembly comprises a gripping actuator, and at least one gripping plate coupled to the gripping actuator. The gripping actuator is configured to move the at least one gripping plate such that the at least one gripping plate engages the target item for picking the target item. The gripping actuator is configured to move the at least one gripping plate such that the at least one gripping plate disengages from the target item for placing the target item. The actuator assembly is configured to slide the arm assembly along a first plane of motion relative to the body. The actuator assembly is configured to slide the arm assembly along a second plane of motion relative to the body, the second plane of motion being different from the first plane of motion. The second plane of motion is perpendicular to the first plane of motion. The first plane of motion is parallel to a longitudinal axis of at least one of the feed conveyor and the escape conveyor, and the second plane of motion is parallel to a transverse axis of at least one of the feed conveyor and the escape conveyor.

According to certain aspects, the feed conveyor is disposed between a first side of the body and a second side of the body opposite the first side. The escape conveyor is configured to couple to the body such that the at least a portion of the escape conveyor is disposed between the first side and the second side. The arm assembly is configured to slidably mount to the body such that the arm assembly and the gripping assembly are disposed between the first side and the second side. The feed conveyor is coupled to at least one of the first side and the second side. The escape conveyor is configured to couple to the body such that the escape conveyor is coupled to at least one of the first side and the second side. The arm assembly is configured to slidably mount to the body such that the arm assembly is coupled to at least one of the first side and the second side. The escape conveyor is configured to couple to the body such that the at least a portion of the escape conveyor is directly above at least a portion of the feed conveyor. The arm assembly is configured to slidably mount to the body such that the arm assembly is above at least one of the escape conveyor and the feed conveyor. The delivery assembly is configured to place the target item onto the at least a portion of the escape conveyor above the feed conveyor. The conveyor system comprises the escapement assembly.

According to various aspects of the subject technology, a method for removing an item from a conveyor system is provided. The method comprises detecting, by a sensor system, a target item of a plurality of items on a feed conveyor. The feed conveyor is configured to facilitate transport of the plurality of items to a first location. The method also comprises picking, by a delivery assembly, the target item from the feed conveyor, and placing, by the delivery assembly, the target item onto an escape conveyor. At least a portion of the escape conveyor is above the feed conveyor. The escape conveyor is configured to facilitate transport of the target item to a second location different from the first location.

According to certain aspects, the target item is visually detected by the sensor system. The method comprises transmitting, by the sensor system, a detection signal to a controller based on the detection of the target item. The detection signal comprises at least one of an indication of the detection, identification information of the target item, a position of the target item, a velocity of the target item, and an acceleration of the target item. The method comprises determining, by the controller, at least one of a pickup location of the target item on the feed conveyor and a pickup time of the target item based on the detection signal. The method comprises generating, by the controller, a delivery signal based on the determined pickup location and/or pickup time, the delivery signal comprising at least one of an instruction to pick the target item, the pickup location, the pickup time, an instruction to place the target item, a place location on the escape conveyor, and a place time of the target item on the escape conveyor. The method comprises transmitting the delivery signal to the delivery assembly. The target item is picked by the delivery assembly based on the delivery signal. The target item is placed by the delivery assembly based on the delivery signal.

According to certain aspects, the delivery assembly comprises an arm assembly configured to slidably mount to a body of a conveyor system with an actuator assembly. The conveyor system comprises the feed conveyor. The delivery assembly further comprises a gripping assembly coupled to the arm assembly. Picking the target item comprises gripping, by the gripping assembly, the target item. The method comprises sliding, with the actuator assembly, the arm assembly such that the gripping assembly is transported to the pickup location or the place location. The arm assembly is slid along a first plane of motion relative to the body and a second plane of motion relative to the body. The second plane of motion is different from the first plane of motion. The second plane of motion is perpendicular to the first plane of motion.

According to certain aspects, the gripping assembly comprises a gripping actuator and at least one gripping plate coupled to the gripping actuator. Picking the target item comprises moving, with the gripping actuator, the at least one gripping plate such that the at least one gripping plate engages the target item. Placing the target item comprises moving, with the gripping actuator, the at least one gripping plate such that the at least one gripping plate disengages from the target item. The target item is placed onto the at least a portion of the escape conveyor above the feed conveyor.

According to various aspects of the subject technology, a machine-readable medium encoded with executable instructions for removing an item from a conveyor system is provided. The instructions comprise code for detecting, by a sensor system, a target item of a plurality of items on a feed conveyor. The feed conveyor is configured to facilitate transport of the plurality of items to a first location. The instructions also comprise code for picking, by a delivery assembly, the target item from the feed conveyor, and placing, by the delivery assembly, the target item onto an escape conveyor. At least a portion of the escape conveyor is above the feed conveyor. The escape conveyor is configured to facilitate transport of the target item to a second location different from the first location.

According to various aspects of the subject technology, an escapement assembly for removing an item from a conveyor system is provided. The escapement assembly comprises a sensor system configured to detect a target item of a plurality of items on a feed conveyor of a conveyor system. The feed conveyor configured to facilitate transport of the plurality of items to a first location in a first direction. The escapement assembly also comprises an escape conveyor configured to couple to a body of the conveyor system such that at least a portion of the escape conveyor is above the feed conveyor. The escapement assembly also comprises a delivery assembly configured to pick the target item from the feed conveyor and to place the target item onto the escape conveyor. The delivery assembly is configured to traverse a first plane of motion and a second plane of motion to pick the target item and/or place the target item. The second plane of motion is different from the first plane of motion. The escape conveyor is configured to facilitate transport of the target item to a second location in a second direction. The second location is different from the first location. The second direction is different from the first direction.

According to certain aspects, the delivery assembly is configured to couple to the body such that the delivery assembly is above at least one of the escape conveyor and the feed conveyor.

According to various aspects of the subject technology, a conveyor system is provided. The conveyor system comprises a body and a feed conveyor coupled to the body. The feed conveyor is configured to facilitate transport of a plurality of items thereon to a first location. The conveyor system also comprises an escapement assembly. The escapement assembly comprises a sensor system configured to detect a target item of the plurality of items on the feed conveyor, an escape conveyor, and a delivery assembly configured to pick the target item from the feed conveyor and to place the target item onto the escape conveyor. The escape conveyor is configured to facilitate transport of the target item to a second location different from the first location. The delivery assembly is configured to traverse a first plane of motion and a second plane of motion to pick the target item and/or place the target item. The second plane of motion is different from the first plane of motion.

According to certain aspects, the delivery assembly is configured to only traverse the first plane of motion and the second plane of motion. In some aspects, the delivery assembly is configured to traverse a first axis and a second axis to pick the target item and/or place the target item, the second axis being different from the first axis. The first axis is perpendicular to the second axis. The first axis is a horizontal axis, and the second axis is a vertical axis. In some aspects, the delivery assembly is configured to only traverse the first axis and the second axis. In some aspects, the delivery assembly is configured to traverse a third plane of motion to pick the target item and/or place the target item. The third plane of motion is parallel with the second plane of motion. The first plane of motion is perpendicular to the third plane of motion and to the second plane of motion. In some aspects, the delivery assembly is configured to only traverse the first plane of motion, the second plane of motion, and the third plane of motion.

According to various aspects of the subject technology, an escapement assembly for removing an item from a conveyor system is provided. The escapement assembly comprises a sensor system configured to detect a target item of a plurality of items on a feed conveyor of a conveyor system. The feed conveyor is configured to facilitate transport of the plurality of items to a first location. The escapement assembly also comprises an escape conveyor and a delivery assembly configured to pick the target item from the feed conveyor and to place the target item onto the escape conveyor. The escape conveyor is configured to facilitate transport of the target item to a second location different from the first location. The delivery assembly is configured to traverse a first plane of motion and a second plane of motion to pick the target item and/or place the target item, the second plane of motion being different from the first plane of motion.

According to certain aspects, the delivery assembly is configured to only traverse the first plane of motion and the second plane of motion. In some aspects, the delivery assembly is configured to traverse a first axis and a second axis to pick the target item and/or place the target item, the second axis being different from the first axis. The first axis is perpendicular to the second axis. The first axis is a horizontal axis, and the second axis is a vertical axis. In some aspects, the delivery assembly is configured to only traverse the first axis and the second axis. In some aspects, the delivery assembly is configured to traverse a third plane of motion to pick the target item and/or place the target item. The third plane of motion is parallel with the second plane of motion. The first plane of motion is perpendicular to the third plane of motion and to the second plane of motion. In some aspects, the delivery assembly is configured to only traverse the first plane of motion, the second plane of motion, and the third plane of motion.

According to various aspects of the subject technology, a method for removing an item from a conveyor system is provided. The method comprises detecting, by a sensor system, a target item of a plurality of items on a feed conveyor. The feed conveyor is configured to facilitate transport of the plurality of items to a first location. The method also comprises picking, by a delivery assembly, the target item from the feed conveyor, and placing, by the delivery assembly, the target item onto an escape conveyor configured to facilitate transport of the target item to a second location different from the first location. Picking the target item and/or placing the target item comprises moving the delivery assembly along a first plane of motion and a second plane of motion. The second plane of motion is different from the first plane of motion.

According to certain aspects, the delivery assembly is only moved along the first plane of motion and the second plane of motion.

According to various aspects of the subject technology, a machine-readable medium encoded with executable instructions for removing an item from a conveyor system is provided. The instructions comprise code for detecting, by a sensor system, a target item of a plurality of items on a feed conveyor. The feed conveyor is configured to facilitate transport of the plurality of items to a first location. The instructions also comprise code for picking, by a delivery assembly, the target item from the feed conveyor, and placing, by the delivery assembly, the target item onto an escape conveyor configured to facilitate transport of the target item to a second location different from the first location. Picking the target item and/or placing the target item comprises moving the delivery assembly along a first plane of motion and a second plane of motion. The second plane of motion is different from the first plane of motion.

According to certain aspects, the delivery assembly is only moved along the first plane of motion and the second plane of motion.

According to various aspects of the subject technology, a conveyor system is provided. The conveyor system comprises a body and a feed conveyor coupled to the body. The feed conveyor is configured to facilitate transport of a plurality of items thereon to a first location. The conveyor system also comprises an escapement assembly. The escapement assembly comprises a sensor system configured to detect a target item of the plurality of items on the feed conveyor, an escape conveyor, and a delivery assembly configured to pick the target item from the feed conveyor and to place the target item onto the escape conveyor. The escape conveyor is configured to facilitate transport of the target item to a second location different from the first location.

According to certain aspects, the escape conveyor is coupled to the body such that at least a portion of the escape conveyor is above the feed conveyor.

According to various aspects of the subject technology, an escapement assembly for removing an item from a conveyor system is provided. The escapement assembly comprises a sensor system configured to detect a target item of a plurality of items on a feed conveyor of a conveyor system. The feed conveyor is configured to facilitate transport of the plurality of items to a first location. The escapement assembly also comprises an escape conveyor and a delivery assembly configured to pick the target item from the feed conveyor and to place the target item onto the escape conveyor. The escape conveyor is configured to facilitate transport of the target item to a second location different from the first location.

According to certain aspects, the escape conveyor is configured to couple to a body of the conveyor system such that at least a portion of the escape conveyor is above the feed conveyor.

According to various aspects of the subject technology, a method for removing an item from a conveyor system is provided. The method comprises detecting, by a sensor system, a target item of a plurality of items on a feed conveyor. The feed conveyor is configured to facilitate transport of the plurality of items to a first location. The method also comprises picking, by a delivery assembly, the target item from the feed conveyor. The method also comprises placing, by the delivery assembly, the target item onto an escape conveyor. The escape conveyor is configured to facilitate transport of the target item to a second location different from the first location.

According to certain aspects, at least a portion of the escape conveyor is above the feed conveyor.

According to various aspects of the subject technology, a machine-readable medium encoded with executable instructions for removing an item from a conveyor system is provided. The instructions comprise code for detecting, by a sensor system, a target item of a plurality of items on a feed conveyor. The feed conveyor is configured to facilitate transport of the plurality of items to a first location. The instructions also comprise code for picking, by a delivery assembly, the target item from the feed conveyor. The instructions also comprise code for placing, by the delivery assembly, the target item onto an escape conveyor. The escape conveyor is configured to facilitate transport of the target item to a second location different from the first location.

According to certain aspects, at least a portion of the escape conveyor is above the feed conveyor.

According to various aspects of the subject technology, a processor comprising one or more modules configured to perform the method or function described in any of the foregoing examples is provided. In some aspects, a machine-readable medium encoded with executable instructions for performing the method or function described in any one of the foregoing examples is provided. In some aspects, an apparatus comprising components operable to perform the method or function described in any one of the foregoing examples is provided.

In some aspects, any of the foregoing examples may depend from any one of the other examples. In some aspects, any of the examples may be combined with any other examples. In some aspects, the methods and/or modules described above can be represented in drawings.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “front,” “rear,” “upward,” “downward,” “left,” “right,” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. An escapement assembly for removing an item from a conveyor system, the escapement assembly comprising:
a sensor system configured to detect a target item of a plurality of items on a feed conveyor of a conveyor system, the feed conveyor configured to facilitate transport of the plurality of items to a first location;
an escape conveyor configured to couple to a body of the conveyor system such that at least a portion of the escape conveyor is above the feed conveyor; and
a delivery assembly configured to pick the target item from the feed conveyor and to place the target item onto the escape conveyor,
wherein the escape conveyor is configured to facilitate transport of the target item to a second location different from the first location.

2. The escapement assembly of claim 1, wherein each of the plurality of items comprises a carton of one or more eggs, and wherein the target item comprises an open carton of one or more eggs.

3. The escapement assembly of claim 1, wherein the escape conveyor is configured to couple to the body such that the escape conveyor is disposed between a first side of the body and a second side of the body, wherein the feed conveyor is disposed between the first side of the body and the second side of the body, and wherein the second side of the body is opposite the first side of the body.

4. The escapement assembly of claim 1, wherein the escape conveyor is configured to couple to the body such that the at least a portion of the escape conveyor is substantially parallel with at least a portion of the feed conveyor.

5. The escapement assembly of claim 1, wherein the feed conveyor is configured to facilitate transport of the plurality of items in a first direction, and wherein the escape conveyor is configured to facilitate transport of the target item in a second direction different from the first direction.

6. The escapement assembly of claim 5, wherein the second direction is opposite the first direction.

7. The escapement assembly of claim 1, wherein a height of the second location is greater than a height of the first location.

8. The escapement assembly of claim 1, wherein the delivery assembly comprises:
an arm assembly configured to slidably mount to the body with an actuator assembly; and
a gripping assembly coupled to the arm assembly, the gripping assembly configured to grip the target item.

9. The escapement assembly of claim 8, wherein the gripping assembly comprises:
a gripping actuator; and
at least one gripping plate coupled to the gripping actuator,
wherein the gripping actuator is configured to move the at least one gripping plate such that the at least one gripping plate engages the target item for picking the target item, and
wherein the gripping actuator is configured to move the at least one gripping plate such that the at least one gripping plate disengages from the target item for placing the target item.

10. The escapement assembly of claim 8, wherein the actuator assembly is configured to slide the arm assembly along a first plane of motion relative to the body, and wherein the actuator assembly is configured to slide the arm assembly along a second plane of motion relative to the body, the second plane of motion being different from the first plane of motion.

11. The escapement assembly of claim 10, wherein the second plane of motion is perpendicular to the first plane of motion.

12. The escapement assembly of claim 10, wherein the first plane of motion is parallel to a longitudinal axis of at least one of the feed conveyor and the escape conveyor, and wherein the second plane of motion is parallel to a transverse axis of at least one of the feed conveyor and the escape conveyor.

13. The escapement assembly of claim 8, wherein the feed conveyor is disposed between a first side of the body and a second side of the body opposite the first side, wherein the escape conveyor is configured to couple to the body such that the at least a portion of the escape conveyor is disposed between the first side and the second side, and wherein the arm assembly is configured to slidably mount to the body such that the arm assembly and the gripping assembly are disposed between the first side and the second side.

14. The escapement assembly of claim 13, wherein the escape conveyor is configured to couple to the body such that the at least a portion of the escape conveyor is directly above at least a portion of the feed conveyor, and wherein the arm assembly is configured to slidably mount to the body such that the arm assembly is above at least one of the escape conveyor and the feed conveyor.

15. The escapement assembly of claim 1, wherein the delivery assembly is configured to place the target item onto the at least a portion of the escape conveyor above the feed conveyor.

16. A machine-readable medium encoded with executable instructions for removing an item from a conveyor system, the instructions comprising code for:
detecting, by a sensor system, a target item of a plurality of items on a feed conveyor, the feed conveyor configured to facilitate transport of the plurality of items to a first location;
picking, by a delivery assembly, the target item from the feed conveyor; and
placing, by the delivery assembly, the target item onto an escape conveyor, wherein at least a portion of the escape conveyor is above the feed conveyor, and wherein the escape conveyor configured to facilitate transport of the target item to a second location different from the first location.

17. The machine-readable medium of claim 16, wherein the instructions further comprise code for receiving from the sensor system a detection signal based on the detection of the target item.

18. The machine-readable medium of claim 17, wherein the detection signal comprises at least one of an indication of the detection, identification information of the target item, a position of the target item, a velocity of the target item, and an acceleration of the target item.

19. The machine-readable medium of claim 17, wherein the instructions further comprise code for determining at least one of a pickup location of the target item on the feed conveyor and a pickup time of the target item based on the detection signal.

20. The machine-readable medium of claim 19, wherein the instructions further comprise code for generating a delivery signal based on the determined pickup location and/or pickup time, the delivery signal comprising at least one of an instruction to pick the target item, the pickup location, the pickup time, an instruction to place the target item, a place location on the escape conveyor, and a place time of the target item on the escape conveyor.

21. The machine-readable medium of claim 20, wherein the instructions further comprise code for transmitting the delivery signal to the delivery assembly.

22. The machine-readable medium of claim 21, wherein the target item is picked and/or placed by the delivery assembly based on the delivery signal.

23. An escapement assembly for removing an open carton of one or more eggs from a conveyor system, the escapement assembly comprising:
a sensor system configured to detect an open carton of one or more eggs of a plurality of cartons of one or more eggs on a feed conveyor of a conveyor system, the feed conveyor configured to facilitate transport of the plurality of cartons of one or more eggs to a first location in a first direction;
an escape conveyor configured to couple to a body of the conveyor system such that at least a portion of the escape conveyor is above the feed conveyor; and
a delivery assembly configured to pick the open carton of one or more eggs from the feed conveyor and to place the open carton of one or more eggs onto the escape conveyor,
wherein the delivery assembly is configured to traverse a first plane of motion and a second plane of motion to pick the open carton of one or more eggs and/or place the open carton of one or more eggs, the second plane of motion being different from the first plane of motion,
wherein the escape conveyor is configured to facilitate transport of the open carton of one or more eggs to a second location in a second direction,
wherein the second location is different from the first location, and
wherein the second direction is different from the first direction.
